(19) United States
(12) Patent Application Publication
(10) Pub. No.: US 2015/0224024 A1
(43) Pub. Date: Aug. 13, 2015

(54) Compression Band with Acupressure Devices and Acupressure Devices for Use with a Compression Band

(71) Applicant: Tae Woo Yoo, Chungcheongman-do (KR)

(72) Inventor: Tae Woo Yoo, Chungcheongman-do (KR)

(21) Appl. No.: 14/451,943

(22) Filed: Aug. 5, 2014

(30) Foreign Application Priority Data
Feb. 10, 2014 (KR) 10-2014-0014611

(51) Int. Cl. A61H 39/04

(52) U.S. Cl. CPC A61H 39/04

(57) ABSTRACT

A compression band with acupressure devices in which each acupressure device is separately included into a pocket and the pocket can be attached to or detached from the compression band in a manner of the number and the position as needed so that the acupressure devices stimulate acupuncture spots or painful spots on the body to improve blood circulation and so that they can be positioned according to the symptom to be treated and closely contacted to the skin to give effective acupressure stimulations.

### BACKGROUND OF THE INVENTION

The present invention relates to a compression band with acupressure devices, and more particularly, to a compression band with acupressure devices where each acupressure device is separately included into a pocket and the pocket can be attached to or detached from the compression band in a manner of the number and the position as needed. Said acupressure devices stimulate acupuncture spots or painful spots on the body to improve blood circulation, as well as the acupressure devices themselves for use with a compression band. And, as acupressure devices can be attached to or detached from the compression band, they can be positioned according to the symptom to be treated and closely contacted to the skin to give effective acupressure stimulations.

Generally, a finger-pressure therapy, in which pain can be relieved or treated by pressing pain spots with fingers or devices, has been conventionally performed as a traditional therapy. As an example of the finger-pressure therapy, an acupressure belt has been disclosed in Korean Utility Model Registration Nos. 20-0299946 and 20-0311331 which has been commercially used in order to treat muscle pains and skeletal diseases. Said belt is made by elastic fabrics, having securing elements at the opposite ends and a plurality of metal acupressure devices fixed to the appropriate positions of the belt. When the belt is worn on the waist or abdomen, a plurality of the metal acupressure devices stimulate the acupuncture spots on the skin. However, since the metal acupressure devices are fixed on the belt, they stimulate not only spots to be treated but also spots which are not subject to acupressure during the acupressure operation. Thus, said belt provides less treatment effect and has rather drawbacks that it brings the user to uncomfortable feelings or pains.

### SUMMARY OF THE INVENTION

The present invention was designed to solve the aforementioned problems occurring when the acupressure devices are fixed to the belt.

An object of the present invention is to provide a compression band with acupressure devices which can be selectively positioned to spots to be treated by attaching to or detaching them from the band, as well as the acupressure devices themselves for use with the compression band.

In order to attain the above object, the present invention comprises pockets containing acupressure devices which can be selectively attached to and detached from the elastic band via fastening means such as Velcro. Said pockets are made by combining the front face with a mesh material with the rear side equipped with hooks of Velcro in a state of acupressure devices being inserted into between them. The elastic band has a large part with loop of the Velcro which enables pockets containing acupressure devices to be attached or detached.

The present invention can freely choose the position of the acupressure devices on the compression band so that a plurality of the protrusions of the acupressure devices can stimulate the symptom spots only and thus prevent pain occurring when wide portions are acupressed and improve the treatment effect. The acupressure devices of the present invention can give acupressure on the symptom spots equally and efficiently because the curved surface can closely contact with the skin.

### BRIEF DESCRIPTION OF THE DRAWINGS

The above and other objects and features of the present invention will be hereinafter explained in detail with reference to the accompanying drawings.

FIG. 1 is an exploded perspective view of an acupressure device with a pocket according to the present invention.

FIGS. 2a and 2b are combined perspective views of an acupressure device in a pocket according to the present invention shown from the front and the rear sides.

FIG. 3 is a cross-sectional view of an acupressure device in a pocket according to the present invention.

FIG. 4 is an illustrated view showing a state of acupressure devices being attached to the compression band according to the present invention.

FIGS. 5a and 5b are an illustrated view showing a state of wearing the compression band and an enlarged cross-sectional view showing a part of the compression band of the present invention, respectively.

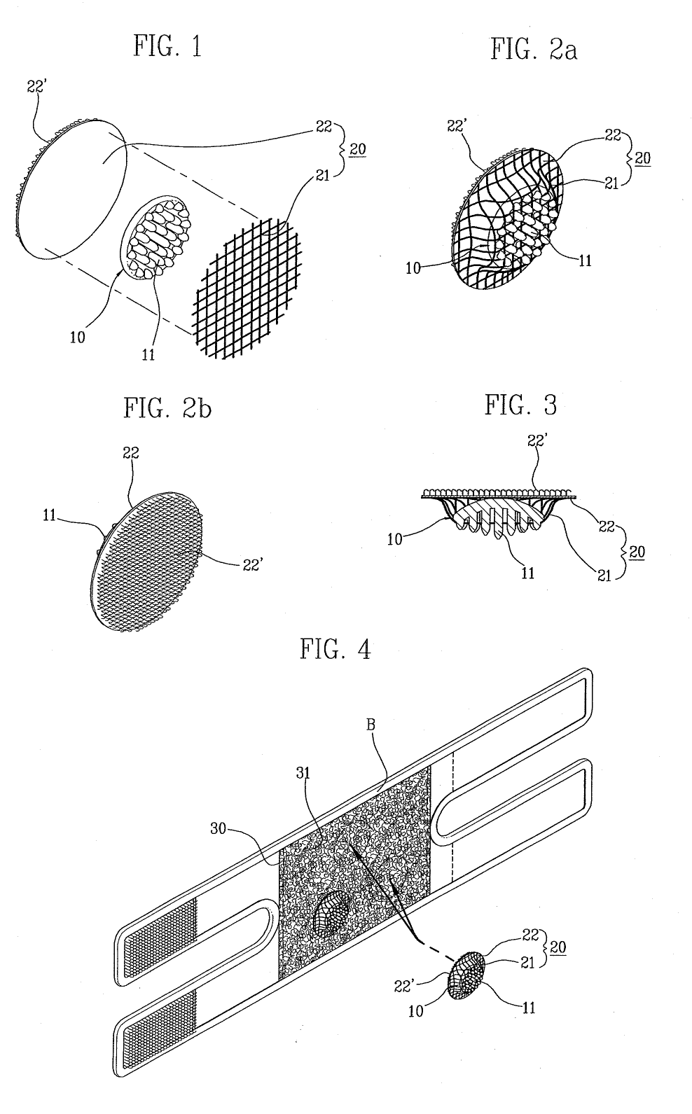

### DESCRIPTION OF THE PREFERRED EMBODIMENTS

The present invention is related to acupressure devices (10) with a plurality of protrusions (11) which can be selectively attached or detached from the elastic band (B), as shown in FIG. 3. The acupressure devices (10) are contained in a pocket (20) whose front face is made of mesh materials (21) to allow a plurality of protrusions (11) to be projected and its rear side is made of hooks (22′) of Velcro (22). That is, the pocket (20) is made by combining the front mesh materials (21) with the rear side hooks of Velcro (22) in a state of an acupressure device (10) being inserted between them.

The acupressure devices (10) are preferably in a size of a coin to stimulate locally a specific acupressure spot distributed on the body and its rear part to be contacted with Velcro (22) is preferably formed in a curved shape.

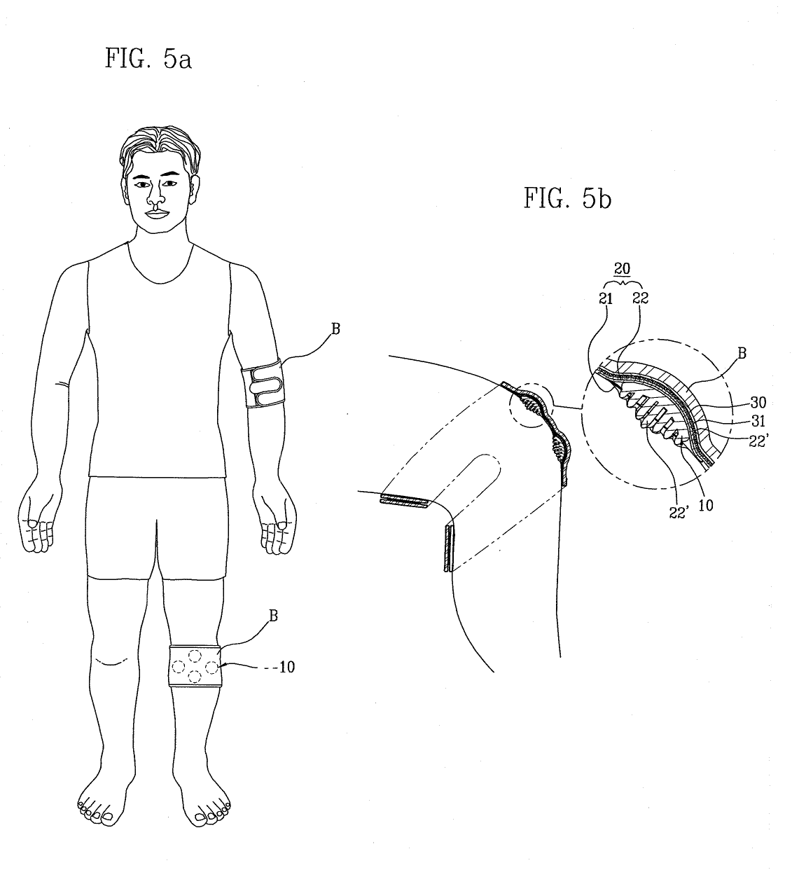

As shown in FIG. 4, the pocket (20) containing the acupressure devices (10) is attached to the elastic band (B). In the band (B), loops (31) of Velcro (30) are positioned in a large area, corresponding to hooks of Velcro (22′) of the pocket (20), to allow the pocket to be attached or detached freely via the interaction of the Velcro (22) (30). Thus, corresponding to the symptom to be treated, the position of the acupressure devices can be freely selected with one or more pockets to be attached to the band. By selecting the position and wearing the band, as shown in FIGS. 5a and 5b, the compression band can exactly stimulate on the spots corresponding to the symptom to improve treatment effect and avoid pain caused by wide acupressure.

When the acupressure devices (10) are pressed by the elastic action of the band (B), as shown in FIG. 5b, the acupressure devices are closely contacted with the skin along their curved shape that acupressure can be performed equally and efficiently.

As described above, pockets (20) containing acupressure device (10) with hooks (22′) are attached or detached from the band (B) with loops (30) through the interaction of the Velcro (22). However, it is also possible that the pocket (20) containing acupressure device (10) is attached or detached from the band (B) via a button such as snap button.

What is claimed is:

1. An acupressure device for a compression band comprising:
at least one pocket, each pocket having a front side formed of a mesh material and a rear side formed of a material having a first fastening arrangement for securement to a compression band at any of a plurality of positions; and
at least one acupressure device, each acupressure device contained in a respective pocket.

2. An acupressure device for a compression band according to claim 1, wherein said first fastening arrangement includes one of hooks and loops which is adapted to engaged with a said second fastening arrangement including the other of hooks and loops on the compression band.

3. An acupressure device for a compression band according to claim 1, wherein each said acupressure device includes a plurality of protrusions which extend outwardly through said mesh material.

4. A compression band with acupressure devices, comprising:
at least one pocket, each pocket having a front side formed of a mesh material and a rear side formed of a material having a first fastening arrangement;
at least one acupressure device, each acupressure device contained in a respective pocket; and
an elastic textile band including:
a securing arrangement at opposite ends thereof adapted for securing the elastic band to a body part of a person, and
a portion between said opposite ends, said portion having a second fastening arrangement for securing said at least one pocket thereto at any of a plurality of positions through said first fastening arrangement, with said acupressure device in said pocket extending outwardly therefrom and adapted to apply acupressure to the body part.

5. A compression band with acupressure devices, according to claim 4, wherein said first fastening arrangement includes one of hooks and loops which is adapted to engaged with a said second fastening arrangement including the other of hooks and loops on the compression band.

6. A compression band with acupressure devices, according to claim 4 wherein each said acupressure device includes a plurality of protrusions which extend outwardly through said mesh material.
